(19) United States
(12) Patent Application Publication
(10) Pub. No.: US 2008/0111787 A1
(43) Pub. Date: May 15, 2008

(54) ELECTROPHORETIC DISPLAY DEVICE AND METHOD OF DRIVING THE SAME

(75) Inventors: HO-YONG JUNG, YONGIN-SI, GYEONGGI-DO (KR); CHEOL-WOO PARK, SUWON-SI (KR); SUNG-JIN HONG, SEOUL (KR)

Correspondence Address: CANTOR COLBURN, LLP, 20 Church Street, 22nd Floor, Hartford, CT, 06103, US

(73) Assignee: SAMSUNG ELECTRONICS CO., LTD., SUWON-SI (KR)

(21) Appl. No.: 11/933,235

(22) Filed: Oct. 31, 2007

(30) Foreign Application Priority Data
Nov. 9, 2006 (KR) 10-2006-0110426

(51) Int. Cl. G02F 1/167; G09G 3/34

(52) U.S. Cl. 345/107

(57) ABSTRACT

The electrophoretic display device includes an electrophoretic display portion which maintains a displayed image even during a shut-down of power, a thin film transistor substrate connected to the electrophoretic display portion to drive the electrophoretic display portion, a driving circuit connected to the electrophoretic display portion and the thin film transistor substrate to supply an image signal which drives the electrophoretic display portion, a switching portion which controls an operation of the driving circuit, a test portion which tests an input image signal and a controller which compares the input image signal tested in the test portion with a display image signal previously inputted and operates the driving circuit portion by operating the switching portion if the input image signal is different from the display image signal.

This application claims priority to Korean Patent Application No. 2006-0110426, filed on Nov. 9, 2006, and all the benefits accruing therefrom under 35 U.S.C. §119, the contents of which in its entirety are herein incorporated by reference.

### BACKGROUND OF THE INVENTION

1. Field of the Invention

The present invention relates to an electrophoretic display (“EPD”) device and a method of driving the same, and more particularly, to an EPD device which is capable of reducing power consumption thereof by blocking power and signal input while a displayed image remains unchanged, and a method of driving the EPD device.

2. Description of the Related Art

An EPD device displays an image using an electrophoretic phenomenon in which colored particles are moved by an electric field applied from an external device. Herein, the electrophoretic phenomenon refers to when an electric field is applied to a dispersion system formed by dispersing charged particles in a fluid, the charged particles therein move within the fluid by Coulomb's force.

The EPD device displays a gray level by shifting a black colored particle positively (+) or negatively (−) charged and a white colored particle charged with a polarity opposite to the polarity of the black colored particle. In other words, when an electric field is applied to the EPD device such that the black colored particle moves toward a surface of the EPD device, the black colored particle absorbs all of the light on the surface of the EPD device, thereby displaying a black color. Meanwhile, when an electric field is applied to the EPD device such that the white colored particle moves toward the surface of the EPD device, the white colored particle reflects all of the light, thereby displaying a white color.

However, when no electric field is applied to the EPD device during a sufficient period of time to allow the charged particles to shift within the EPD device, the charged particles do not completely move toward the surface of the EPD device, thereby displaying a gray color instead of a black or white color. In this way, an electric field is applied to the EPD device for a period of time in which the charged particles may not entirely move toward the surface of the EPD device in order to display a gray color. In other words, a conventional EPD device displays white, gray and black colors by controlling the duration of time that an electric field is applied.

The conventional EPD device is advantageous to a still image rather than a moving image, and is widely used for a display device, such as a device for mobile communication or advertisement, which displays a same image during a long period of time, since the conventional EPD device provides more eyestrain relief as compared to a liquid crystal display device, for example, but not limited thereto. Although the conventional EPD device displays the same image during a long period of time, there is a problem in which the EPD device consumes a significant amount of power during the period of time in which the same image is displayed.

### BRIEF SUMMARY OF THE INVENTION

The present invention provides an electrophoretic display (“EPD”) device capable of significantly reducing power consumption thereof by blocking power and signal input while a displayed image signal remains unchanged and a method of driving the EPD device.

In an exemplary embodiment of the present invention, an EPD includes an EPD portion, a thin film transistor (“TFT”) substrate connected to the EPD portion to drive the EPD portion, a driving circuit connected to the EPD portion and the TFT substrate to supply an image signal which drives the EPD portion, a switching portion which controls an operation of the driving circuit, and a controller which compares an input image signal with a display image signal previously inputted and operates the driving circuit portion by operating the switching portion if the input image signal is different from the display image signal.

In an exemplary embodiment, the EPD further includes a test portion which tests the first image signal at a constant period. In another exemplary embodiment, the electrophoretic display device may include a plurality of capsules or a plurality of sidewalls defining spaces.

In another exemplary embodiment, the constant period is about 0.05 seconds to about 0.2 seconds.

In another exemplary embodiment, the EPD device may further include a storage portion which stores the display image signal of a frame displayed on the EPD portion.

In another exemplary embodiment, the storage portion is mounted within the driving circuit.

In another exemplary embodiment, the storage portion is a read-only memory.

In another exemplary embodiment, the controller stops the driving circuit portion by shutting down the switching portion if the input image signal is the same with the display image signal.

In another exemplary embodiment, the controller shuts down a power supplied to the driving circuit portion and the thin film transistor substrate if the input image signal is the same with the display image signal.

In another exemplary embodiment, the controller drives the switching portion after a re-driving interval elapses, and then drives the driving circuit portion so as to display the image signal stored in the storage portion.

In another exemplary embodiment, the re-driving interval is about 1 hour to about 24 hours.

In another exemplary embodiment of the present invention, a method of driving an EPD device includes receiving an input image signal, comparing the input image signal with a display image signal, maintaining an EPD portion by shutting down a power if the input image signal is the same as the display image signal and displaying the input image signal on the EPD portion if the input image signal is different from the display image signal.

In one exemplary embodiment, the comparing the input image signal with the display image signal may include testing the input image signal and comparing the input image signal with the display image signal.

In another exemplary embodiment, the testing the input image signal may include testing the input image signal at a constant period.

In another exemplary embodiment, the method of driving the EPD device further includes storing the display image signal displayed on the EPD portion.

In another exemplary embodiment, the maintaining the EPD portion if the input image signal is the same as the display image signal further includes displaying the display image signal on the EPD portion again after a re-driving interval elapses.

In another exemplary embodiment, the re-driving interval is about 1 hour to about 24 hours.

### BRIEF DESCRIPTION OF THE DRAWINGS

The above and other aspects, features and advantages of the present invention will become more apparent by describing exemplary embodiments thereof with reference to the accompanying drawings, in which:

FIG. 1 is a block diagram of an exemplary embodiment of an electrophoretic display (“EPD”) device in accordance with the present invention;

FIG. 2 is a cross-sectional schematic diagram view illustrating a structure of an exemplary embodiment of an EPD portion and a thin film transistor (“TFT”) substrate in accordance with the present invention;

FIG. 3 is a schematic diagram view illustrating an exemplary embodiment of a process of fixing the EPD portion to the TFT substrate shown in FIG. 2;

FIG. 4 is a cross-sectional schematic diagram view illustrating a structure of the TFT substrate in accordance with the present invention;

FIGS. 5A to 5C are schematic diagram views illustrating states of charged particles in each gray level of the exemplary EPD device in accordance with the present invention;

FIG. 6 is a flowchart illustrating an exemplary embodiment of a method of driving the exemplary EPD device in accordance with the present invention;

FIG. 7 is a waveform diagram illustrating an exemplary embodiment of an image signal for a voltage application mode and a re-driving mode in the exemplary method of driving the EPD device in accordance with the present invention;

FIGS. 8A and 8B are waveform diagrams illustrating exemplary examples of the image signal in accordance with the present invention; and

FIG. 9 is a cross-sectional schematic diagram view illustrating a structure of another exemplary embodiment of an EPD portion and a TFT substrate in accordance with the present invention.

### DETAILED DESCRIPTION OF THE INVENTION

The present invention is described more fully hereinafter with reference to the accompanying drawings, in which exemplary embodiments of the invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” other elements or features would then be oriented “above” or “upper” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

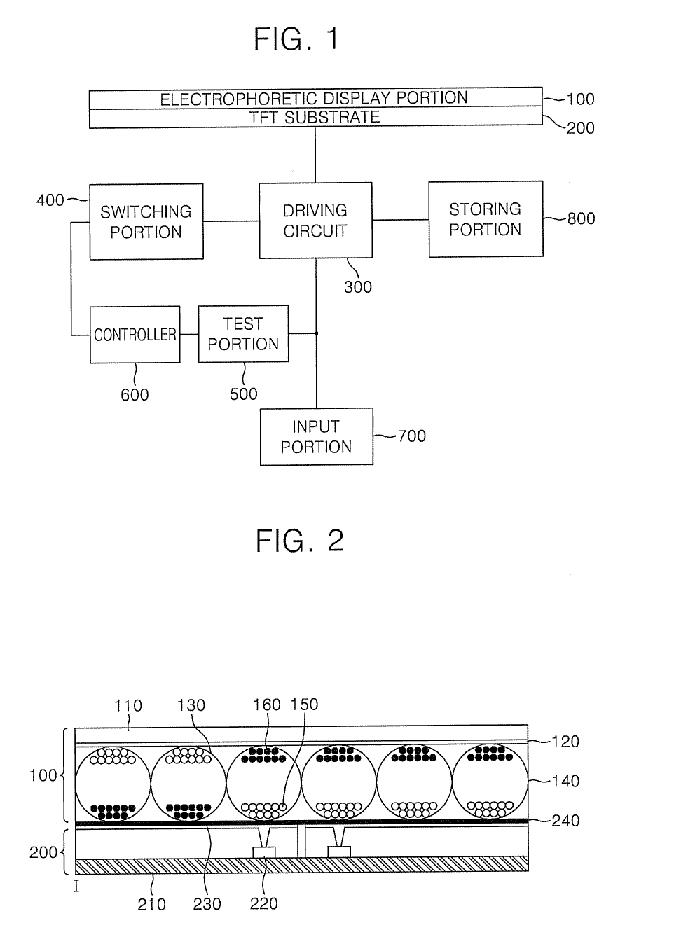

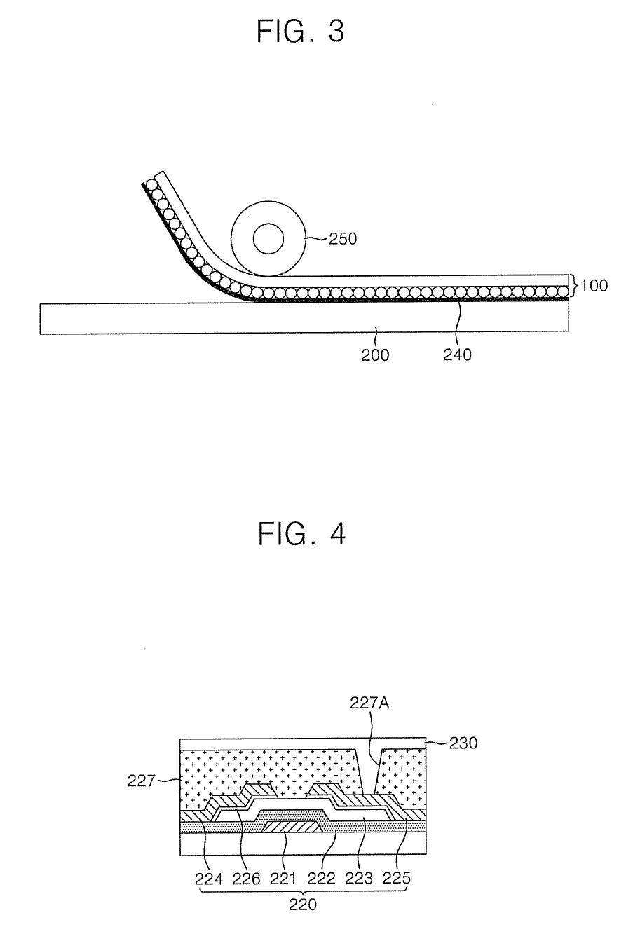

FIG. 1 is a block diagram illustrating an exemplary electrophoretic display (“EPD”) device in accordance with the present invention, FIG. 2 is a cross-sectional schematic diagram view illustrating a structure of an exemplary EPD portion and an exemplary thin film transistor (“TFT”) substrate in accordance with the present invention and FIG. 3 is a schematic diagram view illustrating an exemplary process of fixing the electrophoretic display EPD portion to the exemplary TFT substrate shown in FIG. 2.

As shown in FIG. 1, the EPD device includes an EPD portion 100, a TFT substrate 200, a driving circuit 300, a switching portion 400, a test portion 500, a controller 600, an input portion 700 and a storing portion 800.

The EPD portion 100 is an element which displays an image and which maintains displayed information even when a power is shut-down. That is, particles displaying an image do not move and maintain their positions even if the power is shut-down after the image is displayed. This property is a general property of the EPD device.

As shown in FIG. 2, the EPD portion 100 includes a first substrate 110, a common electrode 120, a capsule 130, an insulating material 140, a white charged particle 150 and a black charged particle 160.

The first substrate 110 is formed of a transparent material and includes a thin flat structure. In exemplary embodiments, the first substrate 110 may be formed of a glass substrate or a plastic substrate. In an exemplary embodiment, when the EPD portion 100 is flexibly formed in a sheet shape, a flexible plastic substrate is used. Accordingly, in one exemplary embodiment, the first substrate 110 is formed of a transparent and flexible polyethylene phthalate (“PET”) material. However, the first substrate 110 is not limited thereto and may be formed of any material which includes adequate light transmittance.

The common electrode 120 is formed on the first substrate 110. In exemplary embodiments, the common electrode 120 may be formed of a transparent and conductive material such as indium tin oxide (“ITO”), tin oxide (“TO”), indium zinc oxide (“IZO”), or amorphous-ITO (“a-ITO”), for example, but is not limited thereto. The common electrode 120 is formed on an entire surface of the first substrate 110 and receives a common voltage to create an electric field along with a pixel electrode 230, as will be described below.

In exemplary embodiments, the first substrate 110 and the common electrode 120 are formed of a transparent material so that external light is allowed to transmit through the first substrate 110 and the common electrode 120. Since the EPD device is a reflective type display device, external light is allowed to transmit through the first substrate 110 and the common electrode 120 in order to reach the charged particle with minimum loss of light. Therefore, in an exemplary embodiment, the first substrate 110 and the common electrode 120 are formed of a transparent material.

The capsule 130 is disposed between the first substrate 110 and a second substrate 210, and contains the insulating material 140, the white charged particle 150 and the black charged particle 160 therein. Therefore, the white charged particle 150 and the black charged particle 160 move within a space defined by an inside of the capsule 130. Meanwhile, use of the capsule 130 may make manufacture of the EPD portion 100 easier and also may prevent deterioration of the EPD portion 100 due to an increase in an operation time of the EPD device.

In exemplary embodiments, as shown in FIG. 9, the EPD portion 100 may be divided into a plurality of horizontal spaces by using a sidewall 131 instead of the capsule 130. Each horizontal space may be filled with the insulating material 140, the white charged particle 150 and the black charged particle 160.

In exemplary embodiments, the insulating material 140 may be liquid or gas. The insulating material 140 functions as a medium through which the white charged particle 150 and the black charged particle 160 move by an electric field. In an exemplary embodiment, the insulating material 140 may be a non-conductive fluid. In the current exemplary embodiment, whether the insulating material 140 is a liquid or a gas depends on the charged particle. Generally, if the insulating material 140 is a gas, the driving speed of the EPD device is good due to an increase in moving speed of the charged particle. Accordingly, in the current exemplary embodiment, the insulating material 140 is a gas, such as air.

Then, the white charged particle 150 is distributed within the insulating material 140. Since the white charged particle 150 is positively (+) or negatively (−) charged, the white charged particle 150 moves in a specific direction due to an electric field which is generated by a power, such as direct current (“DC”) voltages of different polarities, applied to the pixel electrode 230 and the common electrode 162. In an exemplary embodiment, if the white charged particle 150 is positively charged, the white charged particle 150 is attracted to the common electrode 120 which is negatively charged and reflects all light incident from an external source. Thereby, a pixel displays a white color.

Meanwhile, the black charged particle 160 is distributed within the insulating material 140 similar to the white charged particle 150, and is a particle charged with a polarity opposite to that of the white charged particle 150. Accordingly, before a voltage is applied to a pixel, the black charged particle 160 and the white charged particle 150 are mixed with each other within the capsule 130.

Meanwhile, since the black charged particle 160 is charged with the polarity opposite to that of the white charged particle 150, the black charged particle 160 moves in a direction opposite to that of the white charged particle 150 when a power, such as direct current (“DC”) voltages of different polarities, is applied to the pixel electrode 230 and the common electrode 120.

Then, the TFT substrate 200 is attached or connected to the EPD portion 100 and drives the EPD portion 100. FIG. 3 is a schematic diagram view illustrating an exemplary process of attaching the EPD portion 100 to the exemplary TFT substrate 200. Referring to FIG. 3, the EPD portion 100 includes a flexible structure and a sheet shape. An adhesive 240 which adheres to the TFT substrate 200 is formed on an entire lower surface of the EPD portion 100. The EPD portion 100 is pressed by a roller 250 in order to be attached to the TFT substrate 200. Before the attachment of the EPD portion 100 and the TFT substrate 200, an alignment process is performed in order to precisely attach the EPD portion 100 to the TFT substrate 200. The EPD portion is easily attached to the TFT substrate in this lamination process, and thus a process of manufacturing the EPD device is thereby simplified.

Meanwhile, the TFT substrate 200 includes the second substrate 210, a TFT 220 and the pixel electrode 230, as shown in FIG. 2.

The second substrate 210 is positioned opposite to the first substrate 110. In an exemplary embodiment, the second substrate 210 includes a surface which faces a surface of the first substrate 110. In further exemplary embodiments, the second substrate 210 may be formed of either a transparent material or an opaque material since it is not necessary for the second substrate 210 to transmit light. In the current exemplary embodiment, the second substrate 210 is formed of a transparent glass substrate. A TFT 220 and the pixel electrode 230 are formed on the second substrate 210 for driving each pixel independently.

FIG. 4 is a cross-sectional schematic diagram view illustrating a structure of the exemplary TFT substrate in accordance with the present invention. Then, as shown in FIG. 4, the TFT 220 includes a gate electrode 221, a gate insulating layer 222, an active layer 223 and source and drain electrodes 224 and 225, respectively. The gate electrode 221 is connected to a gate line (not shown) and applies a scan signal to the TFT 220. The gate insulating layer 222 insulates the gate electrode 221 from the source and drain electrodes 224 and 225, respectively, or the gate electrode 221 from the active layer 223.

The active layer 223 is formed to overlap with an upper portion of the gate electrode 221. The active layer 223 forms a channel between the source electrode 224 and the drain electrode 225. In an exemplary embodiment, an ohmic contact layer 226 may be further formed on an upper portion of the active layer 223. The ohmic contact layer 226 reduces a contact resistance between the source and drain electrodes 224 and 225 and the active layer 223 and reduces a difference of work function therebetween, thus improving the operational characteristics of the TFT 220.

The source electrode 224 is connected to a data line (not shown) and applies a data signal to the TFT 220. The drain electrode 225 is formed to face the source electrode 224 and to connect to the pixel electrode 230. A protection layer 227 is formed to protect an upper portion of the TFT 220. The protection layer 227 insulates the source and drain electrodes 224 and 225 from each other and is disposed between the pixel electrode 230 and the source and drain electrodes 224 and 225 acting as an insulator therebetween. A contact hole 227A which exposes a part of the drain electrode 225 is formed in the protection layer 227. The pixel electrode 230 is connected to the drain electrode 225 through the contact hole 227A.

The pixel electrode 230 receives a pixel voltage supplied through the drain electrode 225. Thereby, the pixel electrode 230 creates an electric field along with the common electrode 120. The white and black charged particles 150 and 160 move in a specific direction due to the electric field in order to display a white, gray, or black color.

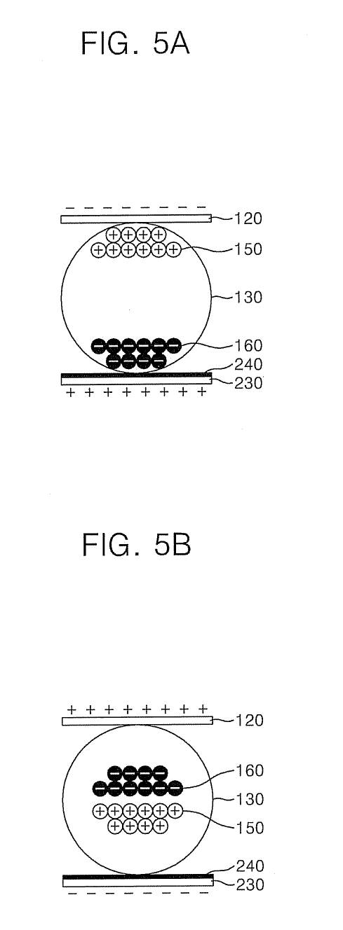

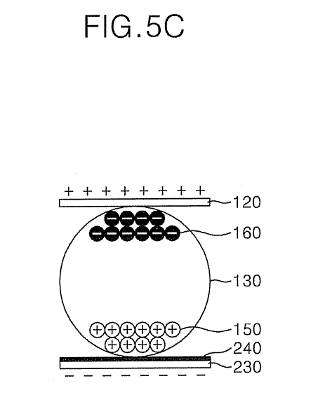

A method of displaying a gray level using the EPD device according to an exemplary embodiment of the present invention will now be described in detail with reference to FIGS. 5A to 5C. FIGS. 5A to 5C are schematic diagram views illustrating states of the white and black charged particles 150 and 160 in each gray level of the exemplary EPD device.

FIG. 5A is a schematic diagram view illustrating a state of the white and black charged particles 150 and 160 in displaying a white color. Referring to FIG. 5A, the common electrode 120 receives a negative (−) voltage and the pixel electrode 130 receives a positive (+) voltage. Then, the white charged particle 150, which exists within the capsule 130 and is positively charged, moves toward the common electrode 120. A power is applied for a period of time to allow the white charged particle 150 to move toward the top of the capsule 130. Then, the white charged particle 150 is positioned substantially around the top of the capsule 130. Therefore, an external light transmitted toward the common electrode 120 is entirely reflected such that a white color is displayed. At this time, the black charged particle 160, which exists within the capsule 130 and is negatively charged, moves toward the pixel electrode 230 and is thereby positioned substantially around the bottom of the capsule 130.

FIG. 5B is a schematic diagram view illustrating a state of the white and black charged particles 150 and 160 in displaying a gray color. Referring to FIG. 5B, the common electrode 120 receives a positive (+) voltage and the pixel electrode 230 receives a negative (−) voltage. Then, the black charged particle 160, which exists within the capsule 130 and is negatively charged, moves toward the common electrode 120. If a power is shut down before the black charged particle 160 completely moves from the inside of the capsule 130 to an upper portion of the capsule 130, the black charged particle 160 stops at a middle portion of the capsule 130 and maintains the position. Therefore, a portion of an external light is reflected and a portion of the external light is absorbed such that a gray color is displayed. At this time, the white charged particle 150 which is negatively charged moves toward the pixel electrode 230 for a certain period of time, stops moving and maintains a position.

FIG. 5C is a schematic diagram view illustrating a state of the white and black charged particles 150 and 160 for displaying a black color. Referring to FIG. 5C, the common electrode 120 receives a positive (+) voltage and the pixel electrode 230 receives a negative (−) voltage. Then, the black charged particle 160, which exists within the capsule 130 and is negatively charged, moves toward the common electrode 120. Then, a power is applied for a period of to allow the black charged particle 160 to move toward the upper portion of the capsule and thus the black charged particle 160 is positioned substantially around the upper portion of the capsule 130. Therefore, an external light is entirely absorbed by the black charged particle 160 such that a black color is displayed. At this time, the white charged particle 150 which is positively charged moves toward the pixel electrode 230 and is positioned substantially around the bottom of the capsule 130.

As described above, the EPD device controls a gray level by controlling a period of time during which a power is applied. In other words, if a power is applied for a period of time to allow the charged particle to move completely, then a white color or a black color is displayed. However, if a power is not applied for a sufficient period of time to allow the charged particle to move completely, then a gray color is displayed. Accordingly, various brightness of a gray color may be controlled by controlling a period of time for which a power is applied.

Referring back to FIG. 1, the driving circuit 300 is connected to the EPD portion 100 and the TFT substrate 200 and supplies an image signal and a power so as to drive the EPD portion 100. The driving circuit 300 includes various electronic elements mounted on a printed circuit board.

The input portion 700 supplies the image signal supplied from outside of the driving circuit 300. The test portion 500 is connected to a line which connects the input portion 700.to the driving circuit 300. The test portion 500 repeatedly tests the image signal input from the input portion 700 by periods. If an input image signal is the same as a display image signal, then the EPD device is maintained at a stopped state. However, if the input image signal is different from the display image signal, a new image is displayed by driving the EPD device.

In the current exemplary embodiment, the period at which the test portion 500 tests the image signal is about 0.05 seconds to about 0.2 seconds in consideration of a driving speed of the charged particle. Since the driving speed of the white and black charged particles 150 and 160 according to the current exemplary embodiment is relatively slow, about 100 microseconds to about 200 microseconds is required for the white and black charged particles 150 and 160 to entirely move toward the upper portion of the capsule 130. Therefore, if the period is greater than 0.2 seconds, then the time gap for which a new image signal is not displayed is too long. If the period is less than 0.05 seconds, then the test portion 500 inefficiently tests the image signal too often as compared with the driving speed of the charged particle.

Further, the switching portion 400 is connected to the driving circuit 300, as shown in FIG. 1, and controls an operation of the driving circuit 300. The controller 600 is positioned between the test portion 500 and the switching portion 400 and controls an operation of the switching portion 400. In particular, the controller 600 compares the input image signal tested in the test portion 500 with the display image signal previously inputted. If the input image signal is the same as the display image signal, then the controller 600 controls the switching portion 400 to stop an operation of the driving circuit 300. If the input image signal is different from the display image signal, then the controller 600 controls the switching portion 400 to operate the driving circuit 300.

Accordingly, if the input image signal is the same as the display image signal, then the driving circuit 300, and the EPD portion 100 and the TFT 220 connected thereto are not driven by a shut-down of power. The image previously displayed on the EPD portion 100 is maintained even when both the EPD portion 100 and the TFT 220 do not operate. As a result, a still image continues to be displayed.

Meanwhile, if the input image signal is different from the display image signal, then a new image signal is displayed on the EPD portion 100. Accordingly, the controller 600 operates the driving circuit portion 300 by controlling the switching portion 400. Then, the input image signal inputted through the input portion 700 is processed by the driving circuit 300 and then supplied to the TFT substrate 200 and the EPD portion 100. Accordingly, an image according to the input image signal is displayed on the EPD portion 100.

The EPD device according to the current exemplary embodiment of the present invention further includes a storage portion 800. The storage portion 800 stores an image signal of a frame displayed on the EPD portion 100. In other words, the storage portion 800 stores an image signal which is supplied to the EPD portion 100 and the TFT substrate 200 and displayed on the EPD portion 100. The display image signal previously stored is used when the controller 600 compares the display image signal with the input image signal, and is also used when the EPD portion 100 is re-driven after a re-driving interval elapses.

In exemplary embodiments, the storage portion 800 may be formed within the driving circuit portion 300, and may be formed separately, as shown in FIG. 1. In further exemplary embodiments, the storage portion 800 may be a read-only memory (“ROM”) or double data rate (“DDR”) type.

Meanwhile, the EPD device according to the current exemplary embodiment shuts down power when an image displayed on the EPD portion 100 is not changed, and thus all of the elements thereof do not operate. However, if a significant amount of time elapses after an image is displayed, variation of the image by an external cause or an internal cause of the EPD device may occur. Accordingly, after a given time elapses after a previous image is displayed, the image needs to be displayed once again.

In the current exemplary embodiment, to re-display the same image after a certain period of time elapses is referred to as ‘re-driving’, and a time period required for the re-driving is referred to as ‘re-driving interval’. The reason for requiring the re-driving is that the EPD device mainly displays a still image, and in a particular case, may display a still image during no less than a few days. If the same still image is displayed for a long period of time, then the first image displayed may be changed or varied due to an external or internal cause. Accordingly, in the current exemplary embodiment, the re-driving interval is controlled from about 1 hour to about 1 day. In exemplary embodiments, the re-driving interval may depend on a type and a characteristic of the EPD device.

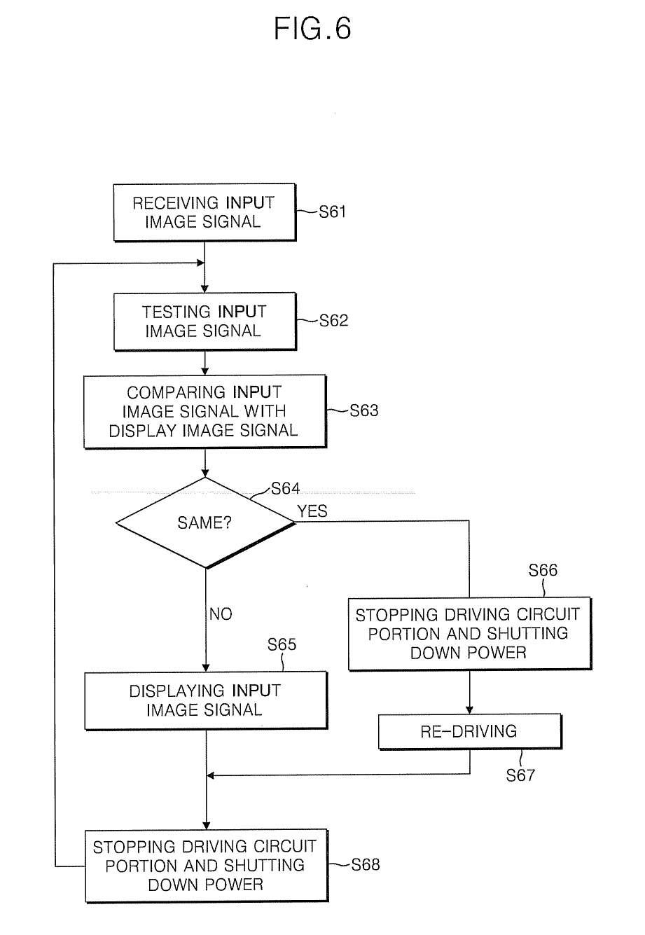

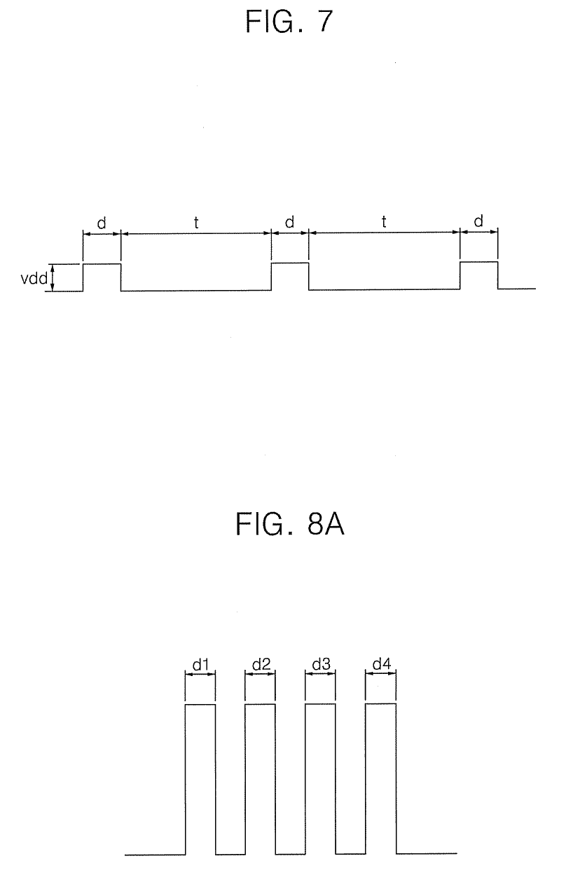

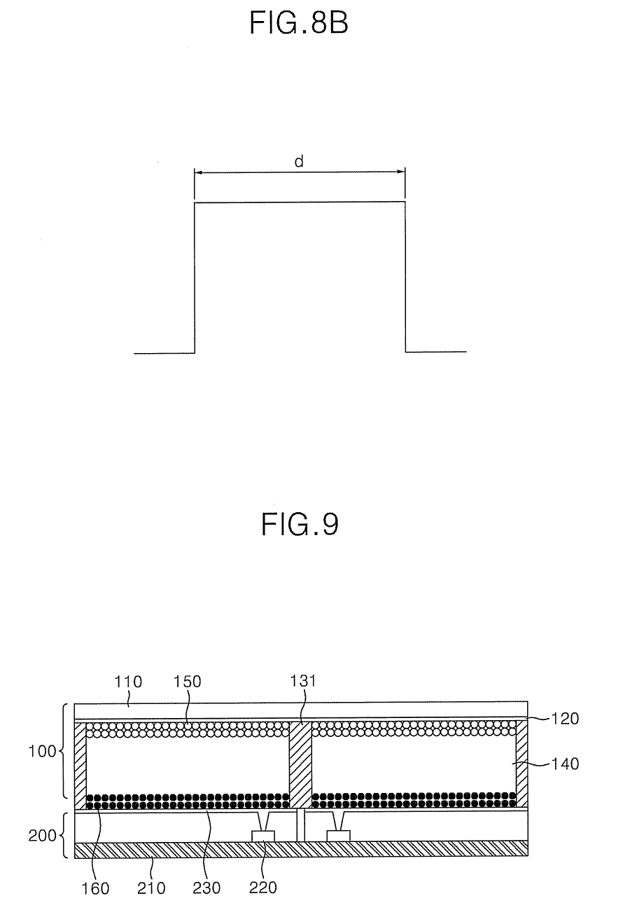

Hereinafter, a method of driving the exemplary EPD device in accordance with the present invention will now be described in further detail with reference to FIGS. 6 to 8. FIG. 6 is a flowchart illustrating an exemplary method of driving the exemplary EPD device in accordance with the present invention and FIG. 7 is a waveform diagram illustrating an image signal for a voltage application mode and a re-driving mode in the exemplary method of driving the exemplary EPD device in accordance with the present invention. FIGS. 8A and 8B are waveform diagrams illustrating examples of an image signal in accordance with the present invention.

Referring to FIG. 6, the input image signal is received (step S61). The input image signal is received through the input portion 700 from outside of the driving circuit 300 at a constant period. The input image signal is tested in the test portion 500 (step S62) and compared with the display image signal (step S63). A determination of whether the input image signal is the same as the display image signal (step S64) is made.

If the input image signal is the same as the display image signal, then an operation of the driving circuit portion 300 is stopped and a power supplied to the EPD device is shut down (step S66). Therefore, the power that the EPD device consumes is controlled and thus power consumption of the EPD device may be significantly reduced. A mode in which an operation of the EPD device is stopped and a constant image is displayed is referred to as an ‘idle mode’.

If the idle mode continues for a long period of time, then the exemplary EPD device is re-driven to re-display the same image (step S67). Re-driving the electrophoretic display device, not to display a new image, but however, to re-display the same image again is referred to as a ‘re-driving mode’. In the re-driving mode, since the image previously displayed on the EPD portion 100 is displayed again, the previous display image signal is again supplied to the EPD portion 100 and the TFT substrate 200. Accordingly, the display image signal stored in the storage portion 800 is again supplied to the EPD portion 100 and the TFT 220 through the driving circuit portion 300, and thus the same image is displayed.

The re-driving mode is followed again by the idle mode (step S68), and thus operation of the driving circuit portion 300 is stopped and a power supplied to the EPD device is shut down.

Meanwhile, as a result of comparing the input image signal with the display image signal, if the input image signal is different from the display image signal, then the input image signal is displayed on the EPD portion 100 (step S65). Therefore, the input image signal is applied to the driving circuit 300, and then supplied to the EPD portion 100 and the TFT substrate 200. Accordingly, an image corresponding to the input image signal is displayed on the EPD portion 100.

The driving circuit 300 processes the input image signal and supplies the input image signal to the EPD portion 100, the TFT substrate 200 and the storage portion 800. Accordingly, the storage portion 800 stores the image signal. The image signal stored in the storage portion 800 becomes the display image signal.

After displaying an image corresponding to the input image signal, the EPD device according to the current exemplary embodiment proceeds to the idle mode (step S68). Therefore, an operation of the driving circuit 300 is stopped and power supplied to the EPD device is shut down.

Hereinafter, an image signal applied to the exemplary EPD device in accordance with the present invention will now be described in further detail with reference to FIG. 7. In the current exemplary embodiment, the image signal is defined by a period of time during which a voltage having a constant level (vdd) is applied. A driving voltage indicates a difference between voltages applied to the common electrode 120 and the pixel electrode 230, and drives the white and black charged particles 150 and 160 filled within the capsule 130. A voltage application time is a more significant factor than the applied voltage level. In other words, the period of time during which the voltage is continuously applied to the common electrode 120 and the pixel electrode 230 defines a moving distance of the white and black charged particles 150 and 160 and thereby a gray level is determined by the moving distance. Accordingly, the voltage application time (d) is a factor which defines a gray level of an image.

In the exemplary method of driving the EPD device according to the present invention, an image signal is not supplied before a re-driving interval (t) elapses after the image signal is applied once. In exemplary embodiments, the re-driving interval ranges from about 1 hour to about 1 day (i.e., 24 hours) as described above. After the re-driving interval elapses, the same voltage as the previous voltage is again applied for the same voltage application time (d) as the previous voltage application time to form the re-driving mode. Meanwhile, in exemplary embodiments, the image signal may be a type of pulse, as shown in FIG. 8A, and a type of DC signal, as shown in FIG. 8B. Although the image signal is a type of pulse, the sum (d1+d2+d3+d4) of respective pulse widths is equal to the voltage application time (d), in exemplary embodiments.

According to the present invention, since an operation of the EPD device is stopped while an image remains unchanged after the image is displayed and all power supplied to the EPD device is shut down, power consumption of the EPD device may thereby be significantly reduced.

Moreover, since an input image signal is tested at a constant period and is compared with the display image signal, if the image signal for displaying a new image is inputted, then the image may be quickly displayed.

Further, although the same image is displayed for a long period of time, a good quality image may be displayed for a long period of time without any variation due to the re-driving mode.

While this invention has been described in connection with what is presently considered to be some practical exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. An electrophoretic display device comprising:
an electrophoretic display portion;
a thin film transistor substrate connected to the electrophoretic display portion to drive the electrophoretic display portion;
a driving circuit connected to the electrophoretic display portion and the thin film transistor substrate to supply an image signal which drives the electrophoretic display portion;
a switching portion which controls an operation of the driving circuit; and
a controller which compares an input image signal with a display image signal previously inputted and operates the driving circuit portion by operating the switching portion if the input image signal is different from the display image signal.

2. The electrophoretic display device of claim 1, further comprising a test portion which tests the input image signal at a constant period.

3. The electrophoretic display device of claim 1, wherein the electrophoretic display portion includes one of a plurality of capsules or a plurality of sidewalls defining spaces.

4. The electrophoretic display device of claim 2, wherein the constant period is about 0.05 seconds to about 0.2 seconds.

5. The electrophoretic display device of claim 2, further comprising a storage portion which stores the display image signal of a frame displayed on the electrophoretic display portion.

6. The electrophoretic display device of claim 5, wherein the storage portion is mounted within the driving circuit.

7. The electrophoretic display device of claim 5, wherein the storage portion is a read-only memory.

8. The electrophoretic display device of claim 1, wherein the controller stops the driving circuit portion by shutting down the switching portion if the input image signal is the same with the display image signal.

9. The electrophoretic display device of claim 8, wherein the controller shuts down a power supplied to the driving circuit portion and the thin film transistor substrate if the input image signal is the same with the display image signal.

10. The electrophoretic display device of claim 9, wherein the controller drives the switching portion after a re-driving interval elapses, and then drives the driving circuit so as to display the image signal stored in the storage portion.

11. The electrophoretic display device of claim 10, wherein the re-driving interval is about 1 hour to about 24 hours.

12. A method of driving an electrophoretic display device, comprising:
receiving an input image signal;
comparing the input image signal with a display image signal;
maintaining an electrophoretic display portion by shutting down a power if the input image signal is the same as the display image signal; and
displaying the input image signal on the electrophoretic display portion if the input image signal is different from the display image signal.

13. The method of claim 12, wherein the comparing the input image signal with the display image signal comprises:
testing the input image signal; and
comparing the input image signal with the display image signal.

14. The method of claim 13, wherein the electrophoretic display portion includes one of a plurality of capsules or a plurality of sidewalls defining spaces.

15. The method of claim 13, wherein the testing the input image signal is testing the input image signal at a constant period.

16. The method of claim 15, wherein the constant period is about 0.05 to about 0.2 seconds.

17. The method of claim 15, further comprising storing the display image signal displayed on the electrophoretic display portion.

18. The method of claim 17, wherein the maintaining the electrophoretic display portion if the input image signal is the same as the display image signal further comprising displaying the display image signal on the electrophoretic display portion again after a re-driving interval elapses.

19. The method of claim 18, wherein the re-driving interval is about 1 hour to about 24 hours.
